(19) United States
(12) Patent Application Publication
(10) Pub. No.: US 2008/0104819 A1
(43) Pub. Date: May 8, 2008

(54) Container-assembling method and device

(76) Inventors: Michael Parsch, Kirchhain (DE); Gunter Simon, Dautphetal (DE); Volker Bier, Fronhausen (DE)

Correspondence Address: CLARK & BRODY, 1090 VERMONT AVENUE, NW, SUITE 250, WASHINGTON, DC, 20005, US

(21) Appl. No.: 11/976,626

(22) Filed: Oct. 26, 2007

(30) Foreign Application Priority Data
Oct. 27, 2006 (DE) 10 2006 051 389.4

(51) Int. Cl. B29C 65/00

(52) U.S. Cl. 29/428; 29/700

(57) ABSTRACT

The invention relates to an assembly device (1) and to a method to reliably mount containers (3) fitted with a self-supporting structure (4), in particular plastic containers (3) for liquid media and chemicals such as liquid engine-fuels, for affixation on stationary or displaceable supports (2). The method comprises the steps: affixing conduits to a support (2); affixing the container (3) on the support (2); and connecting the container (3) to the conduits; where the step of assembling the container (3) to the support (2) includes affixing one connector part (8) each on the support (2) and on the container (3) as well as joining to each other the connector parts (8). Preferably the connector part (8) shall be affixed on the support (2) before the step of affixing the conduits. The assembly device (1) comprises means with which to carry out said method.

The present invention relates to a method and device providing reliable assembly of plastic containers as defined in the respective preambles of claims 1 and 9.

Methods and devices used to assemble plastic containers to supports are widely known. They relate to plastic containers, in particular liquids and chemicals containers, and are mounted by means of a bracket configured at/on the support. The bracket is mounted to the support before the plastic container is put into place. Again, conduits and cables to connect or link the plastic container to the connectors or cables of the said support are assembled before the container is. Other assembly stages such as painting or the like may be carried out before the plastic container is mounted on the support's bracket. Once the plastic container is mounted on the bracket, this bracket is affixed in reliable manner by such means as tightening straps or the like.

In particular said method respectively a corresponding assembly device (tightening straps, bracket) are used to affix plastic containers such as fuel tanks to supports when assembled to light trucks. Illustratively such a support will be a light truck C frame. The bracket is affixed first to the frame and the installation of conduits and cables is carried out at the C frame before the assembly proper to the fuel tank is carried out.

The known state of the art incurs the drawback that the fuel tank must be affixed by prestressed tightening straps and the tightening mounting torques of which must be accurately observed. This kind of assembly moreover is complex and costly. Also the brackets must be affixed before the conduits or cables are, whereby the ensuing procedural and subsequent processing steps are degraded by the brackets already in place. The large brackets also may entail injuries. Not least, due to the way for instance smooth-walled fuel tanks are secured, especially when full braking force is applied, or in accidents and the like, and especially when said tank is full, there will be the danger it shall move (migrate).

Accordingly one objective of the present invention is to create an assembly device and an assembly method that overcome the above drawbacks. In particular the present invention creates an assembly method and device allowing mounting a plastic container in more reliable and simpler, less complex manner on a support.

This objective is met by a method defined in the preamble of claim 1 and by an assembly device defined in claim the preamble of claim 1.

The main features of the present invention are defined in the inventive parts of claim 1 and of claim 9. Embodiments of the present invention are defined in claims 2 through 8 and 10 through 17.

The present invention encompasses the technical disclosure that a method for reliably assembling—for purposes of conduit connection—plastic, self-supporting containers, in particular plastic containers for fuels and chemicals such as automotive fuels, to stationary or displaceable supports, includes the following steps: mounting conduits to the support; mounting the plastic container to the support; and connecting the plastic container to the conduits; the step of mounting the plastic container to the support comprising mounting one connector part each to the support and to the plastic container as well as joining to each other the connector parts, preferably the connector parts being mounted on the support before the conduits are.

The expression “reliable assembly” denotes preventing accidentally displacing the plastic container relative to the support. This feature includes crash-proof assembly. In this respect “crash-proof” means that when the plastic container is affixed to a displaceable support, for instance a motor vehicle (passenger car or light truck) frame, the plastic container shall remain assembled to the support even in the event of accident (crash) rather than come loose. Accordingly a “reliable assembly” meets the requirements for instance of such crash tests as the Euro NCAP Crash Test.

Self-supporting plastic containers are those into which the bearing structure required for strength was integrated into this container. This goal may be attained for instance by thicker materials or by cross-sectionally shaped bars imbedded in them. Said reinforcements preferably are made of the same or a similar material as the plastic container. The self-supporting plastic container also may be built in compound or hybrid manner where the bearing components, for instance the cross-sectionally shaped bars integrated or imbedded into said container, are made of another material than the plastic container.

These plastic containers shall be assembled to supports that may be displaceable or stationary. Such supports preferably are displaceable, for instance light truck C frames. The plastic container first is mounted on the support and then is connected to conduits or cables. A conduit hookup connects the inside space of the plastic container to one or more conduits. The conduits were previously mounted on the support so they need only be connected subsequently to the assembled plastic bottle.

The plastic container is affixed on the support in a way that one connector part each is fitted on the support and the plastic container and the connector parts then are made to be joined operationally. Instead of using tightening straps as in the state of the art, the components of the present invention, namely the support and the plastic container, prior to being joined to each other, are fitted with matching connector parts allowing joining them in simple manner. The support connector part may be mounted before the conduits are affixed. The connector parts are selected appropriately small so that they shall not interfere with the further assembly or processing steps. In particular the connector part affixed to the support is designed in a way precluding injuries. Besides greater compactness, this feature may be enhanced by rounded and/or less projecting components.

Further assembly steps may be carried out between that of mounting the connecting element on the support and joining the connector parts. In the light of the design of the connector part mounted on the support and a bearing structure which now is no longer mounted on the support and illustratively said structure no longer is in the form of comparatively large brackets, said further assembly steps will not be degraded and also the danger of injuries is now reduced.

In one embodiment mode of the present invention, mounting the connector parts includes using substantially geometrically interlocking and cooperating connector parts. As a result the connector parts at the support and at the plastic container may be joined to each other in simple manner. However other connection modes such as compressive, frictional or bonding junctions, even in arbitrary combinations are feasible. Contrary to the case of connector parts cooperating in bonding manner, mechanically interlocking connector parts may be easily disengaged from each other without thereby affecting the reliability of connection. The mechanically interlocking connector parts comprise in particular parts or segments which engage each other in mechanically interlocking manner, thereby providing a mechanically interlocking connection.

In a further embodiment of the present invention, mounting essentially mechanically interlocking cooperating connector parts includes at least one catch element and at least one matching detent element. In this manner the connectors elements are easily joined to each other and the embodiment mode offers security against accidental catch detachment. The present invention offers a further advantage in that the connector parts may be joined to one another without need for tools, thereby simplifying the assembly of the plastic container to the support. By joining the connector parts substantially by means of said mechanically interlocking connector parts, the plastic container is assembled in simple yet reliable manner to the support, and such assembly can be undone as needed.

Mounting the connector part to the plastic container includes affixing the connector part to the self-supporting structure of the plastic container. By means of appropriate structure reinforcements and/or additionally integrated reinforcements, the self-supporting structure of the plastic container is made mechanically strong. To assure reliably assembly, the connector part is mounted on the self-supporting structure that offers adequate mechanical strength for junction with the connector parts.

The step of mounting one connector part each to the support and to the plastic container may include in particular the affixation of several connector parts. The number of connector parts mounted on the support and the number of connector parts mounted on the plastic container preferably are the same. However the number of connectors respectively mounted on the support and/or the plastic container may be different.

Moreover the present invention also technically discloses that an assembly device—offering reliable affixation of self-supporting plastic containers, in particular plastic containers for liquid media and chemicals such as liquid motor fuels—is fitted with means implementing the method of the present invention in order to connect (conduits) to stationary or displaceable supports. The means implementing the method of the present invention are features, embodiment modes, components and the like required in the implementation of said method, illustratively matched connector parts.

Accordingly, in one embodiment mode of the assembly device of the present invention, it is fitted with at least two cooperating and complementary connector parts which can be joined for operation. A first connector element fitted with first connector elements is designed to be mounted on a bearing structure of the plastic container. The mounting means are arbitrary and configured on the plastic container in a component of its bearing structure. Therefore the connector parts may be threaded or plug-in elements partly entering the bearing structure, this feature being problem-free on account of the increased mechanical strength of the bearing structure.

A second connector element is designed to be assembled by means of second connector elements to a support. The first and second connector elements may be identical. Because the second connector elements are mounted on a support such as a light truck frame, they may be fused with or welded onto the support or be bonded to it. The first connector elements may be bonded for instance by fusing/welding to the plastic container's bearing structure. In this instance however the connector parts are affixed by a cross-sectionally contoured bar imbedded in the plastic container using a first affixing element, said bar preferably being made of a different material.

By means of the connector parts respectively mounted on the support and/or on the plastic container's bearing structure, the plastic container and the support may be reliably assembled. The connector parts are fitted with mechanically interlocking elements designed for the mechanically interlocking connection so that they can be joined to each other in mechanically interlocking manner. The mechanically interlocking elements may be arbitrary, for instance being plug-in means or detent means allowing snap in mechanically interlocking connection.

Therefore, in a preferred embodiment mode of the present invention, the mechanically interlocking connector elements are designed as matching detent seat element and/or detent element. In this manner the connector parts easily lock to each other while at the same they preclude accidental separation.

Each connector part may comprise several detent receiving elements and/or detent elements. A connector part may comprise both detent receiving elements and detent elements. In that case the corresponding connector parts comprise both complementary detent elements and catch elements. The connector parts are designed to be complementary to each other. Several connector parts also may be used, mutually complementary connector parts always being joined for operation.

As already discussed above, the connector parts are linked by affixing elements on the support and/or on the plastic container's bearing structure. The affixing elements are designed depending on the given connector part, in particular its shape, its weight and its material. A connector part also may be fitted with different kinds of affixing elements.

Depending on the connector part, the affixing elements may be threaded means, rivets, plug-in types and the like. Making the material of the bearing structure of the plastic container and the connector part is especially significant.

Further features, particulars and advantages of the present invention are disclosed in the claims and in the following description of illustrative embodiment modes in relation to the appended drawings.

FIG. 1 is a perspective view of a plastic container linked by an assembly device to a support,

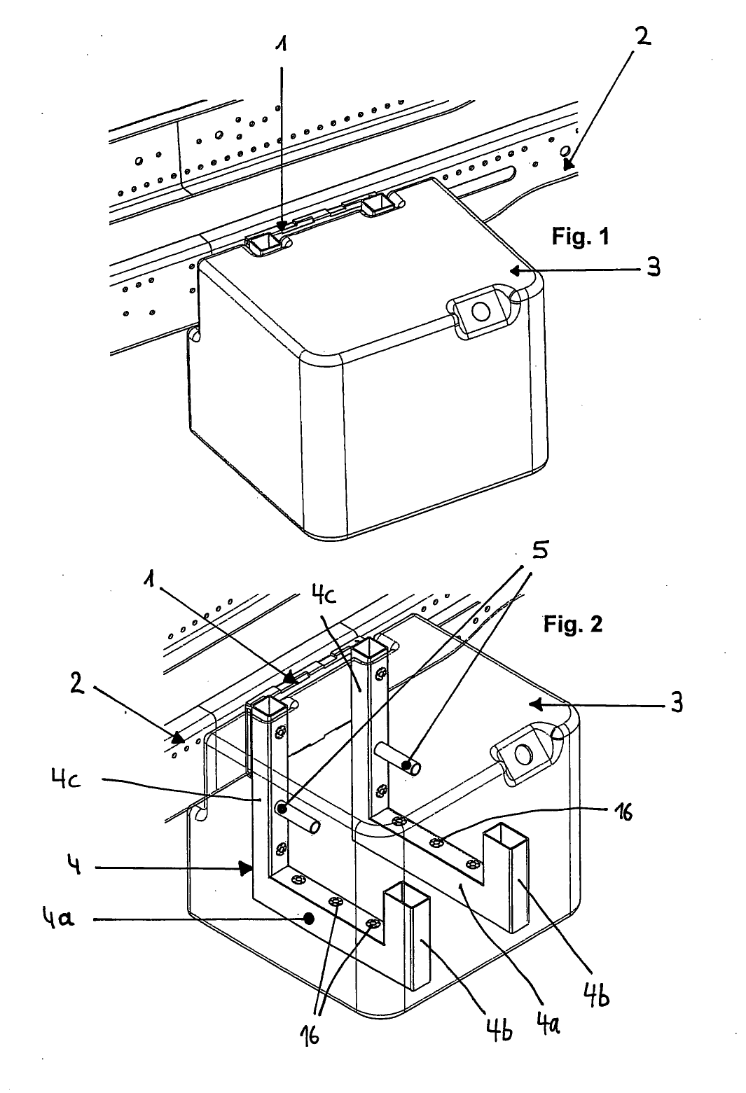

FIG. 2 is a view relating to FIG. 1 showing in more detail a bearing structure of the plastic container,

FIG. 3 is a cross-sectional sideview of a plastic container linked by an assembly device to a support,

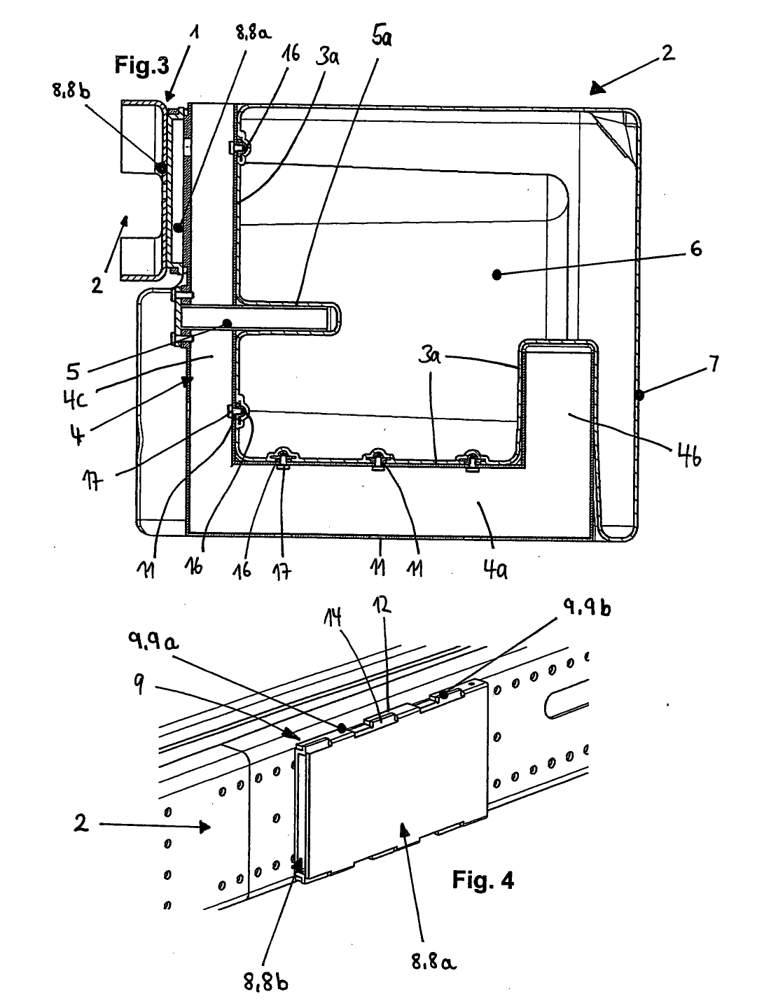

FIG. 4 is a perspective view of one embodiment mode of the connector, parts mounted on the support,

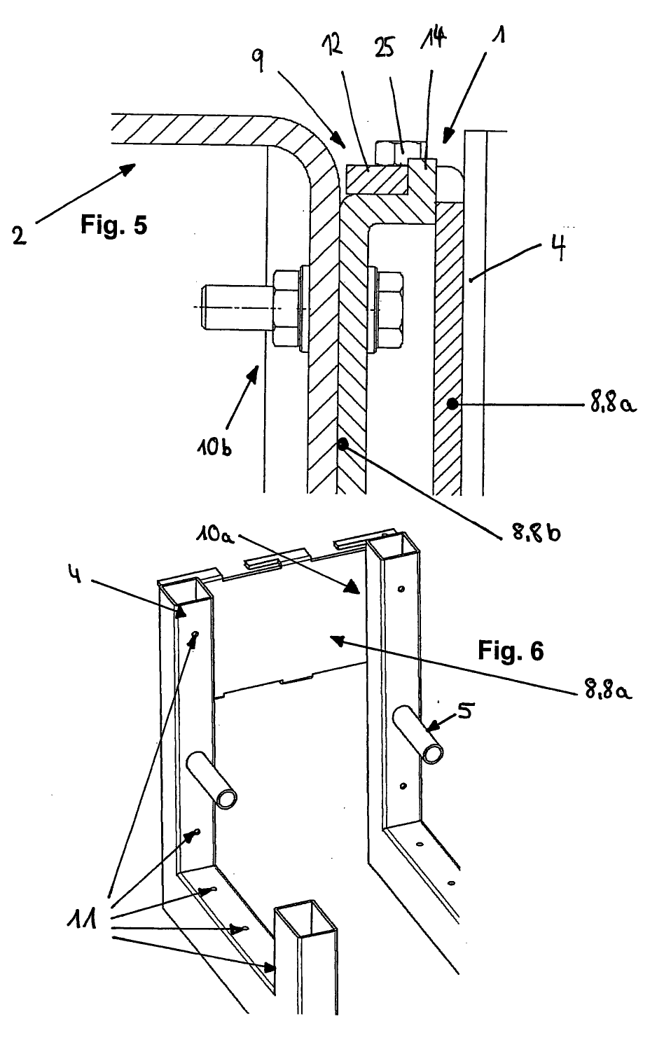

FIG. 5 is a cross-sectional sideview of a cutaway of the assembly device and its connection to the support,

FIG. 6 schematically shows another perspective view of the configuration of the connector part on the plastic container's bearing structure, and

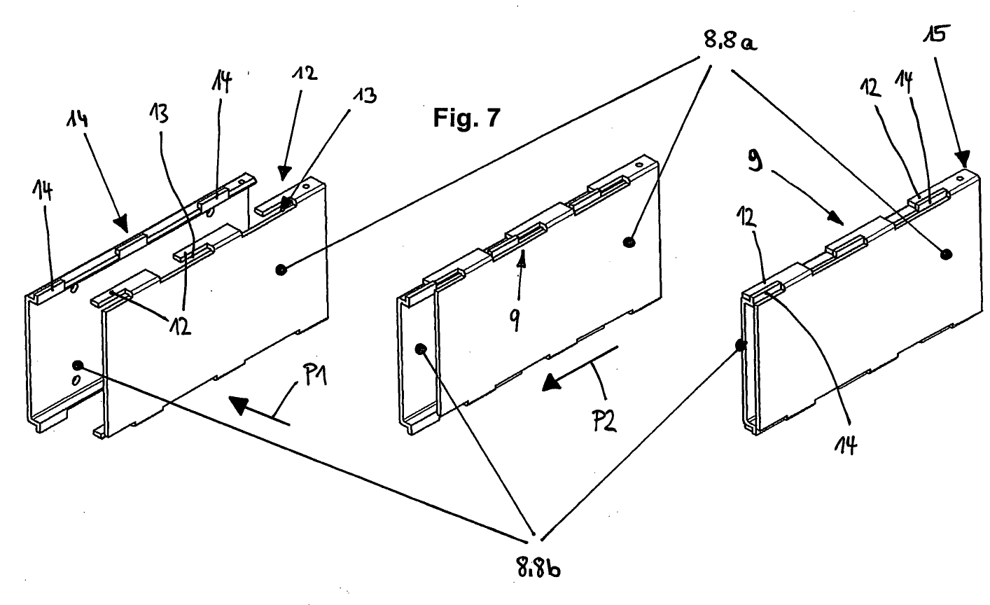

FIG. 7 schematically shows the joining procedure of the two connector parts.

Identical or similar components always are denoted by the same references in the individual Figures.

FIG. 1 is an oblique perspective of a plastic container 3 linked by an assembly device 1 to a support 2. In this embodiment the support 2 is the frame of a light truck (not shown in further detail). In the present case, the plastic container 3 is a liquid-fuel tank. The assembly device 1 allows connecting to each other in particular in crash-safe manner the plastic container 3 and the support 2.

FIG. 2 is the view of FIG. 1, but the plastic container 3 being assumed transparent, and a bearing structure 4 for the plastic container 3 being shown in elucisating detail.

The bearing structure 4 comprises two bracket bars 4a imbedded into the plastic container 3. The bracket bars 4a are approximately U-channels, one leg of the U (for instance the front leg 4b) being shorter than the other (in this instance the leg 4c) facing the light truck's frame 2. The shorter legs 4b each constitute one upwardly facing rest. A pin-like protrusion 5 or stud bolt projects approximately centrally from each of the longer legs 4c of the U-channel and each engages a recess 5a in the plastic wall 7 of the container 3 (FIG. 3).

As shown in FIG. 3, the bracket bars 4a are inserted in two recesses 3a in the container that in substantially geometrically interlocking manner receive said bracket bars 4a. The suspended or already deposited container 3 is already stopped in its position by the upwardly facing recesses 3a or by pockets.

Furthermore continuous boreholes 11 are present in the bearing structure 4 to allow firmly affixing the bracket bar 4a on the plastic container 3. For that purpose screws 17 are inserted through the continuous boreholes 22 into screw/metal inserts 16. These metal inserts 16 are designed as cap nuts or as threaded disks or the like and they are imbedded in the material of the plastic wall 7 of the container 3. It is important in this respect that the wall 7 be reliably sealed relative to the inside space 6 of the plastic container 3.

In this manner a stable permanently fixed connection between the container 3 and the bearing structure 4 is attained, said structure thereby being integrated as a bracket unit into the plastic container 3. The bracket unit 4 does more than providing a rest for the deposited plastic container 3. Said container at the same time is stabilized per se by the bearing structure 4. Also the pocket-like recesses 3a constitute baffle walls or bulkheads effectively restricting movements of the liquid in the container 3.

The assembly device 1 is mounted on the bearing structure 4.

FIG. 3 is a sideview of a cross-section of the plastic container 3 connected by means of the assembly device 1 to the support 3. The container 3 comprises an inside space 6, further the plastic wall 7 and the bearing structure 4 imbedded or integrated into the container 3. Compared to the dimensions of the container 3, the plastic wall 7 is relatively thin. The bearing structure 4 is integrated into the plastic container 3 to make it self-supporting.

The assembly device 1 is fitted with connector parts 8 to simply and rapidly affixing the plastic container 3 to the support 2. A first connector element 8a, illustratively a detent plate with geometrically interlocking elements 9a, is mounted on the plastic container 3, namely at its bearing structure 4 and a second connector element 8b illustratively in the form of a receiving plate fitted with lateral geometrically interlocking elements 9b, is configured on the support 2. The two connector elements 8a and 8b are complementary to each other for instance similarly to a bayonet and detent connection, so that, when mutually engaged, they constitute a reliable detent and/or clamping connection. The connector elements 8a and 8b are shown enlarged in FIG. 4.

FIG. 4 is a perspective view of an embodiment mode of the connector elements 8a and 8b configured on the support 2. In the present instance said elements are fitted with corresponding geometrically interlocking parts 9, first geometrically interlocking elements 9a of the first connector element 8a being complementary to the second geometrically interlocking elements 9b of the second connector element 8b, as a result of which the connector elements 8a, 8b may operationally engage one another in compressive and/or in geometrically interlocking manner. Accordingly the plates 8a, 8b can be snapped into each other by a simple sliding relative displacement, thereby simplifying the assembly of the container 3 to the light truck frame and hence speeding up such assembly.

The mechanically and geometrically interlocking parts 9 are designed in the form of catches and detents 12, 14 implementing mutual engagement of the connector parts 8. The catches 12 preferably and generally are hook-shaped tangs whereas the detents 14 constitute upward and downward protrusions. The catches 12 and protrusions 14 are complementary to each other, as a result of which the connector parts 8 can be made to mutually engage by means of the geometrically interlocking parts 9 in compressive and/or geometrically interlocking manner. Each connector part 8 in the embodiment shown comprises three geometrically interlocking parts 9, though such parts 9 also may be used in different numbers. Several connector parts 8 also may be used.

FIG. 5 is a cross-sectional sideview of a cutaway of the assembly device 1 and of its connection to the support 2. The assembly device 1 in this instance comprises two connector elements 8a, 8b cooperating as a geometrically interlocking catch connection. The connector parts 8 are mounted by second affixing elements 10b, for instance a screw connection, on the support 2, respectively by means of first affixing elements 10a, for instance (omitted) screws, on the bearing structure 4 of the plastic container 3. The designs of the affixing elements 10a,b may be arbitrary provided they assure stationary and reliable affixation of the connector elements 8a, 8b on the support 2 respectively on the bearing structure.

The first connector element 8a is mounted by the first affixing element 10a (not shown here) on the bearing structure 4 whereas the second connector element 8b is connected by the second affixing element 10b to the support 2. In this instance the second affixing element 10b is a screw which by means of a screw shank passes through the second connector element 8b and through a wall of the support 2 and is affixed by a screw head and a nut.

FIG. 6 is an oblique perspective elevation of the configuration of the first connector element 8a on the bearing structure 4 of the plastic container 3. The first connector element 8a comprises the first affixing elements 10a by means of which the first connector element 8a is affixed to the bearing structure 4. In this instance the first affixing means 10a are in the form of welds though they also may be of any appropriate kind assuring securely affixing the connector part 8 and connector element 8a on the bearing structure 4.

FIG. 7 schematically shows the connection procedure for the two connector elements 8a, 8b. Once the connector element 8a linked to the (omitted) bearing structure 4 has been deposited on the connector element 8b screwed into the light truck frame 2 (direction of arrow P1) and has been slightly moved sideways (direction of arrow P2), the connection has been established whereby the catches 12 of the first connector element 8a engage behind the detents 14 of the second connector element 8b and the detents 14 come to rest in the recesses 13 of the catches 12. For clarity, the support 2 and the bearing structure 4 as well as the plastic container 3 are omitted from this Figure.

In this manner the assembly method of the present invention is as simple as can be.

In a first procedural step, the two connector elements 8a, 8b are moved toward each other while being mutually offset, their displacement directions being indicated by the arrows P1 and P2. The first connector element 8a is fitted with its first geometrically interlocking element 9a being the approximately hook-shaped tangs 12, each tang 12 being fitted with a longitudinal clearance 13 and optionally being L-shaped. The second connector element 8b is fitted with second geometrically interlocking elements 9b in the form of up-and-down projecting protrusions 14 of which the outer contour matches the inner contour or the clearances 13, whereby each of these clearances 13 may receive in frictional and/or geometrically interlocking manner a protrusion 14. The geometrically interlocking parts 9 therefore are similar to a bayonet lock and when cooperating constitute a geometrical interlock.

The two connector parts 8 approach each other while also being mutually offset in a manner that they are offset in the longitudinal direction of the clearance, whereby, in their otherwise identical alignment, the protrusion 14 is configured in front of the clearance 13, as shown in the second step of the connection procedure (middle of FIG. 7). Except for this offset, the connector parts 8 are congruent and abutting. Next these connector parts 8 are displaced in the longitudinal direction of the clearance 13, so that they abut and the protrusion 14 is configured in the clearance 13 (right hand in FIG. 7).

It follows that the protrusions 14 of the receiving plate 8b run preferably vertically and are engaged from behind by horizontally angled protrusions 12 of the catch plate 8b FIG. 7, right side). The opposite snap-in configuration may be used as well. The suspended bracket unit 4, 8 already loads the connection by its own weight; said unit is further stabilized by the added weight of the container 3.

Further security is attained in the shown embodiment mode by fitting one of the tangs 13 with a borehole 15 entered by a screw connection 25 (omitted; see FIG. 5) engaging the connector parts 8 and further affixing them to each other.

The invention is not restricted to any of the above described embodiment modes but on the contrary may be modified in many ways. In particular metal containers for instance made of steel, aluminum and the like also may be designed as discussed above or in comparable manner and be assembled without thereby transcending the scope of the invention.

The above discussions make it plain that the invention relates to an assembly device 1 and to a method for reliably mounting containers 3 that comprise a self-supporting structure 4, in particular relating to plastic containers 3 for liquid media and chemicals such as liquid engine-fuels, said containers to be assembled to stationary or displaceable supports 2. The said method comprises the following steps: mounting conduits to a support 2; mounting the container 3 on the support 2 and connecting the container 3 to the conduits; where the step of mounting the container 3 on the support 2 includes affixing a connector part 8 to the support 2 and to the container 3 and further joining these connector parts 8. Preferably the affixation of the connector part 8 on the support 2 takes place before the step of affixing the conduits. The assembly device 1 comprises means to implement the method of the invention.

All features and advantages, inclusive design details, spatial configurations and method steps, flowing from the claims, specification and drawing, may be construed inventive per se as well as in arbitrary combinations.

1. A method to reliably assemble plastic containers (3)—which are fitted with a self-supporting structure (4), in particular plastic containers (3) used for liquid media and chemicals such as liquid motor-fuels—to stationary or displaceable supports (2), comprising the method steps: mounting conduits on the support (2); mounting the plastic container (3) on the support (2); and connecting the plastic container (3) to the said conduits,
characterized in that
the step of mounting the plastic container (3) in the support (2) includes mounting one connector part (8) each on the support (2) and on the plastic container (3) and joining the connector parts (8).

2. Method as claimed in claim 1, characterized in that further mounting steps are carried out between the step of mounting the connector parts (8) on the support (2) and the step of joining the connector parts (8).

3. Method as claimed in claim 1, characterized in that mounting the connector parts (8) includes the affixation of substantially geometrically interlocking and cooperating connector parts (8).

4. Method as claimed in claim 1, characterized in that affixing substantially geometrically interlocking and cooperating connector parts (8) includes affixing at least one detent catch and at least one detent.

5. Method as claimed in claim 1, characterized in that joining the connector parts (8) is carried out without resort to tools.

6. Method as claimed in claim 1, characterized in that joining the connector parts (8) includes joining substantially geometrically interlocking connector parts (8).

7. Method as claimed in claim 1, characterized in that affixing the connector part (8) on the plastic container (3) includes affixing the connector part (8) on the bearing structure (4) of the plastic container (3).

8. Method as claimed in claim 1, characterized in that the step of affixing one connector part (8) each on the support (2) and on the plastic container (3) includes affixing several connector parts (8).

9. An assembly device to securely mount plastic containers (3)—which are fitted with a self-supporting structure (4), in particular plastic containers (3) for liquid media and chemicals such as liquid engine-fuels—on stationary or displaceable supports (2),
characterized in that
the assembly device (1) is fitted with means to carry out the method defined in claim 1.

10. Assembly device (1) as claimed in claim 9, characterized in that it comprises at least two mutually cooperating, complementary connector parts (8) which can be joined to be operational.

11. Assembly device (1) as claimed in claim 9, characterized in that a first connector element (8a) is fitted with first affixing elements (10a) for affixation to the bearing structure (4) of the plastic container (3).

12. Assembly device (1) as claimed by claim 9, characterized in that a second connector element (8b) is fitted with second affixing elements (10b) for affixation to the support (2).

13. Assembly device (1) as claimed in claim 9, characterized in that the connector parts (8) comprise corresponding geometrically interlocking parts (9) to join the connector elements (8) in geometrically interlocking manner.

14. Assembly device (1) as claimed in claim 9, characterized in that the geometrically interlocking parts (9) are designed as catches and/or detents.

15. Assembly device (1) as claimed in claim 9, characterized in that each connector part (8) comprises several catches and/or detents.

16. Assembly device (1) as claimed in claim 9, characterized several connector parts (8) are available.

17. Assembly device (1) as claimed in claim 9, characterized in that the affixing parts (10) are designed as screw connectors, welds, rivets, plug-in connectors and the like.
